(19) United States
(12) Patent Application Publication
(10) Pub. No.: US 2005/0159062 A1
(43) Pub. Date: Jul. 21, 2005

(54) Carbon fiber felts and heat insulating materials

(75) Inventor: Fumikazu Machino, Osaka-shi (JP)

Correspondence Address: PILLSBURY WINTHROP SHAW PITTMAN, LLP, P.O. BOX 10500, MCLEAN, VA, 22102, US

(73) Assignee: Osaka Gas Company Limited, Osaki-shi, Osaka, (JP)

(21) Appl. No.: 10/507,518

(22) PCT Filed: Jan. 29, 2003
(86) PCT No.: PCT/JP03/00821

(30) Foreign Application Priority Data
Mar. 20, 2002 (JP) 2002-79374

(51) Int. Cl. D04H 1/08; B32B 27/04

(52) U.S. Cl. 442/320; 442/325; 442/136

(57) ABSTRACT

To improve fire resistance, a fire resistant agent is included in a carbon fiber felt constituting a carbon fiber aggregate, and a binder resin for bonding the carbon fiber constituting this aggregate. The fire resistant agent comprises a phosphorus-containing compound, a boron-containing compound, a silicone compound, or the like. The proportion of the fire resistant agent is about 1 to 30 parts by weight relative to 100 parts by weight of the carbon fiber. The obtained carbon fiber felt and a heat insulating material formed by the felt are excellent in fire resistance.

### TECHNICAL FIELD

The present invention relates to a carbon fiber felt excellent in fire resistance, a method for producing the same, and a heat insulating material formed by the same.

### BACKGROUND ART

A carbon fiber is excellent in heat resistance, mechanical strength, durability and others, so the carbon fiber is used in various applications. For example, the carbon fiber felt is used as various reinforcing materials and heat insulating materials, and others. Among them, since the carbon fiber is particularly excellent in not only resistance to high temperature but also a shielding property against heat (temperature), it is widely used as a heat insulating material. The carbon fiber is used as heat insulating materials in the field of a semiconductor and functional ceramics. In such a field, the carbon fiber is used as a filer for a heat insulating material used in a high-temperature furnace such as a vacuum furnace, a semiconductor single crystal growth furnace, a ceramic sintering furnace and a C/C composite burning furnace.

Japanese Patent Application Laid-Open No. 227244/1990 (JP-2-227244A) discloses a molded heat insulating material in which a multi-layered felt made of a carbon fiber is bonded with carbide or graphitized material, wherein the bulk density of the carbon fiber-made felt constituting each layer decreases in steps in the direction of at right angles with bonded surface. Moreover, Japanese Patent Application Laid-Open No. 258245/1990 (JP-2-258245A) discloses a molded heat insulating material, wherein a carbon fiber felt is laminated vorticosely with being wound, the carbon fiber felt is unified with carbide of a resin existing between the laminating layers, and the layer of the carbon fiber felt is continuously and evenly (without a wrinkle or a ripple) laminated in the circumferential direction. Furthermore, WO98/38140 discloses an acoustic absorptive heat insulating material in which an aggregate of flocculent carbon fibers comprising a carbon fiber having a mean fiber diameter of 0.5 μm to 5 μm and a mean fiber length of 1 mm to 15 mm, wherein the carbon fibers are bonded with each other by a thermosetting resin. Japanese Patent Application Laid-Open No. 253958/2000 (JP-2000-253958A) discloses a producing method of a cushion article for a chair, wherein a carbon fiber aggregate (or an aggregate of carbon fibers) in which the fibers are tangled each other is impregnated with a thermosetting resin, the carbon fibers are adhered and fixed each other by the thermosetting resin as a binder, and then the carbon fibers acquire elasticity. However, these heat insulating materials or articles do not have enough resistance to high temperature, fire resistance in particular.

Accordingly, it is an object of the present invention to provide a carbon fiber felt (or a felt fabricated from a carbon fiber) with a high fire resistance, a producing method thereof, and a heat insulating material.

It is another object of the present invention to provide, a carbon fiber felt with a high fire resistance without deteriorating a characteristic of a binder resin, a producing method thereof, and a heat insulating material.

It is still another object of the present invention to provide a method to improve fire resistance of a carbon fiber felt conveniently and effectively.

### DISCLOSURE OF THE INVENTION

The inventor of the present invention made intensive studies to achieve the above objects and finally found that a carbon fiber felt having a high fire resistance can be obtained by involving a fire resistant agent in the felt. The present invention was accomplished based on the above finding.

That is, the carbon fiber felt of the present invention comprises a carbon fiber aggregate, and a binder resin to bond the carbon fiber constituting the aggregate, wherein the felt contains a fire resistant agent. The binder resin may comprise a thermosetting resin. The fire resistant agent may be a phosphorus-containing compound, a boron-containing compound, a silicone compound (e.g., a silicone compound having a reactive group), and others. The fire resistant agent may comprise a silicone compound having at least two reactive functional groups. The reactive functional group may be a hydrolytic condensable group (e.g., a halogen atom, a hydroxyl group, and an alkoxy group), an ether group, an epoxy group, a carboxyl group, a mercapto group, an amino group, a substituted amino group, a polymerizable unsaturated group, an isocyanate group and others, and is usually a halogen atom, a hydroxyl group, an alkoxy group and others. The silicone compound may be an organosiloxane (e.g., a polyorganoxiloxane), a silane, and the like. The proportion of the fire resistant agent is about 1 to 30 parts by weight relative to 100 parts by weight of the carbon fiber. The proportion of the binder resin may be about 1 to 50 parts by weight relative to 100 parts by weight of the carbon fiber, and the proportion of the fire resistant agent may be about 1 to 70 parts by weight (e.g., about 1 to 50 parts by weight) relative to 100 parts by weight of the binder resin. The binder resin may contain the fire resistant agent. The carbon fiber may comprise a fine carbon fiber, and for example, the mean diameter of the carbon fiber may be about 0.5 to 5 μm (e.g., about 0.5 to 2 μm). The carbon fiber may comprise a pitch-based carbon fiber. The carbon fiber may comprise an anisotropic carbon fiber. The carbon fiber felt may comprise a web of the carbon fiber (or carbon fiber web) and a thermosetting resin (e.g., a phenolic resin) for bonding (or uniting) the carbon fiber constituting this web, wherein the carbon fiber comprises an anisotropic pitch-based carbon fiber having a mean diameter of about 0.5 to 5 μm (e.g., about 0.5 to 2 μm) and a mean length of about 1 to 15 mm; and the felt contains a fire resistant agent comprising a phosphoric ester, a boric acid and a silicone compound (e.g., a silicone compound having a reactive group) and others, in a proportion of about 1.5 to 25 parts by weight (e.g., about 2 to 20 parts by weight) relative to 100 parts by weight of the carbon fiber.

The present invention also includes a heat insulating material formed by the above-mentioned felt. Moreover, the present invention includes a process for producing a carbon fiber felt comprising a carbon fiber aggregate and a binder resin, which comprises bonding the carbon fiber aggregate by the binder resin in the presence of a fire resistant agent. The process also includes, for example, a process which comprises adhering (or applying) a mixture containing a thermosetting resin and the fire resistant agent to the carbon fiber aggregate, and curing the thermosetting resin to obtain a carbon fiber felt having a bulk density of 1 to 30 kg/m³.

### BEST MODE FOR CARRYING OUT THE INVENTION

The carbon fiber felt of the present invention is a flocculate carbon fiber aggregate (or mixture) bonded by a binder resin, and contains a fire resistant agent. The carbon fiber aggregate usually forms a web in which the carbon fiber tangles randomly.

[Carbon Fiber]

A carbon fiber may include, for example, a pitch-based carbon fiber, a polyacrylonitrile (PAN)-based carbon fiber, a phenol resin-based carbon fiber, a regenerated cellulose-based carbon fiber (e.g., a rayon-based carbon fiber and a polynosic-based carbon fiber), a cellulose-based carbon fiber, a polyvinyl alcohol-based carbon fiber, and the like. The carbon fiber may be an activated carbon fiber. These carbon fibers may be used singly or in combination.

Among these carbon fibers, it is preferred, in the prevent invention, to use a carbon fiber obtained from a pitch (the pitch-based carbon fiber). The pitch-based carbon fiber may be obtained by melt-spinning of a conventional pitch, and a petroleum oil-based, a coal-based pitch, or the like may be used as the pitch.

The pitch-based carbon fiber may be produced through, for example, following steps; a fiber-spinning step to form a pitch-based fiber, an infusibility-giving or a flameproofing step to prevent welding the pitch-based fiber, and a burning step to carbonize or graphitize the pitch-based fiber infusibility-given or flameproofed. These steps may be conducted continuously or discontinuously.

As the fiber-spinning step, a conventional fiber spinning method may be used. For example, a melt-blow method may be used. The melt-blow method comprises discharging the heated and melted pitch from a spinning nozzle, and spurting a heated gas from around the spinning nozzle.

In the infusibility-giving or the flameproofing step, e.g., the pitch-based fiber may be heated by supplying an oxidizing gas (e.g., an air) with a temperature of about 150 to 350° C., and preferably about 160 to 340° C., in an infusible furnace.

As the burning (or baking) step, for example, the following method is available; the pitch-based fiber infusibility-given or flameproofed is heated at about 400 to 4000° C., preferably about 500 to 3000° C., and more preferably at 700 to 2500° C. under an inert atmosphere or a vacuum in a burning furnace. The pitch-based fiber infusibility-given or flameproofed may be graphitized at about 2000 to 4000° C., (preferably about 2300 to 3300° C.) in the burning step.

A carbon precursor (e.g., a pitch) to form the carbon fiber may be an isotropic precursor (e.g., an isotropic pitch) or may be an anisotropic precursor (e.g., an anisotropic pitch). The anisotropic precursor (especially, the anisotropic pitch) is preferred in the view of fire resistance. The anisotropic pitch includes a pitch component, for example, an anisotropic pitch obtained from a polymerization of a condensed polycyclic hydrocarbon (e.g., naphthalene, anthracene, phenanthrene, acenaphthene, acenaphthylene and pyrene). As the carbon fiber, the anisotropic carbon fiber is particularly preferred in the view of fire resistance.

The mean diameter of the carbon fiber may be, for example, about 0.3 to 20 μm, preferably about 0.5 to 10 μm, and more preferably about 0.5 to 5 μm (particularly about 0.5 to 3 μm). In the view of fire resistance, the carbon fiber is preferred to be a fine carbon fiber, and the mean diameter of this fine carbon fiber is about 0.5 to 5 μm, preferably about 0.5 to 3 μm (e.g., about 1 to 3 μm), and particularly about 0.5 to 2 μm (e.g., about 1 to 2 μm). The diameter of the fiber may be controlled by, for example, adjusting the diameter of the spinning nozzle, and others. The fine fiber may for example be obtained by controlling the diameter of the spout of the spinning nozzle to be about 0.2 to 0.5 mm, and adjusting a heat-melting temperature or a discharging rate of the carbon precursor, and a temperature and a spouting rate of the heated gas.

The mean length of the carbon fiber may be, for example, about 0.5 to 20 mm, preferably about 1 to 15 mm, and more preferably about 3 to 12 mm. Incidentally, a fine carbon fiber comprising a short fiber is usually in the form of a mat, the fiber is tangled by an infusibility-giving or flameproofing treatment and a carbonize treatment to form a flocculent fiber aggregate, in many cases.

The carbon fiber may contain other fiber(s) with a high fire resistance such as an inorganic fiber (e.g., a glass fiber, an aluminosilicate fiber, an aluminum oxide fiber, a silicon carbide fiber, a boron fiber and a metal fiber). The proportion of other fiber(s) is about not more than 30 parts by weight, and preferably about not more than 10 parts by weight, relative to 100 parts by weight of the carbon fiber.

[Binder Resin]

As the binder resin, there may be used a thermoplastic resin (e.g., a vinylic resin, an acrylic resin, a styrenic resin, a polyester-series resin, a thermoplastic polyurethane-series resin, and a polyamide-series resin), and a thermosetting resin (e.g., a polyurethane-series resin, an unsaturated polyester-series resin and a phenolic resin). Among these binder resins, the thermosetting resin is preferably used.

Examples of the thermosetting resin may include a phenolic resin (e.g., a resol-based and a novolak-based phenolic resin), a polyimide-series resin (e.g., a polyether imide, a polyamideimide and a polyaminobismaleimide), an amino-series resin (e.g., a urea resin and a melamine resin), a furan resin, a polyurethane-series resin, an epoxy resin (e.g., a bisphenol A-based epoxy resin), an unsaturated polyester-series resin, a diallyl phthalate resin, a vinyl ester resin, a thermosetting acrylic resin, a silicone-series resin, and the like. A conventional curing agent may be used with the thermosetting resin. Among these thermosetting resins, the phenolic resin, the polyimide-series resin and the silicone-series resin, the phenolic resin, in particular, are preferred, in the view of fire resistance.

These binder resins may be used singly or in combination. The proportion of the binder resin is about 1 to 50 parts by weight, preferably about 3 to 40 parts by weight, and more preferably about 5 to 30 parts by weight, relative to 100 parts by weight of the carbon fiber.

[Fire Resistant Agent]

As the fire resistant agent, a conventional flame retardant may be used. The flame resistant agent is not particularly limited to a specific one, and examples may include a phosphorus-containing compound, a boron-containing compound and a silicone compound (a silicon-containing compound). These fire resistant agents may be used singly or in combination. Moreover, the fire resistant agent may have a reactive group (e.g., a group reactive to a resin or a carbon fiber, and a self-condensable group).

The phosphorus-containing compound may include, for example, a phosphoric ester [an aliphatic phosphoric ester (e.g., a triC₁₋₁₀alkyl phosphate such as trimethyl phosphate, triethyl phosphate, tripropyl phosphate and tributyl phosphate), an aromatic phosphoric ester (e.g., a triC₆₋₂₀aryl phosphate such as triphenyl phosphate, tricresyl phosphate, cresyl diphenyl phosphate, and trixylenyl phosphate), an aromatic condensed phosphoric ester (e.g., a bisphosphate such as resorcinol bis(diphenyl phosphate), hydroquinone bis(diphenyl phosphate) and bisphenol A bis(diphenyl phosphate), a polyphosphate corresponding to these bisphosphates), and others], a phosphorous ester [an aliphatic phosphite (e.g., a C₁₋₁₀alkyl phosphite such as trimethyl phosphite), an aromatic phosphite (e.g., a triC₆₋₂₀aryl phosphite such as triphenyl phosphite), and others], a phosphonate (e.g., methyl neopentyl phosphonate), a phosphine oxide (e.g., triphenyl phosphine oxide), a phosphonic ester (e.g., diphenyl methylphosphonate), an inorganic phosphorus compound (e.g., a red phosphorus, phosphoric acid, phosphorous acid, hypophosphorous acid, polyphosphoric acid, or a metallic salt thereof), and others.

Among these phosphorus-containing compounds, the phosphoric ester, in particular, the aromatic (condensed) phosphoric ester is preferred. These phosphorus-containing compounds may be used singly or in combination.

Examples of the boron-containing compound may include a boric acid [a boric acid (e.g., orthoboric acid and metaboric acid), a condensed boric acid (e.g., pyroboric acid, tetraboric acid, pentaboric acid and octaboric acid), or a metallic salt thereof, and others], and a borane (e.g., an alkylborane such as trimethylborane, methyldiborane and trimethyldiborane, and an arylborane such as triphenylborane).

Among these boron-containing compounds, the boric acid, particularly the boric acid or a metallic salt thereof, is preferred. These boron-containing compounds may be used singly or in combination.

The silicone compound (silicon-containing compound) includes, for example, an organosiloxane [an organosiloxane (e.g., a diC₁₋₁₀alkyl siloxane such as dimethyl siloxane, a C₁₋₁₀alkyl C₆₋₂₀aryl siloxane such as methyl phenyl siloxane, and a diC₆₋₂₀aryl siloxane such as diphenyl siloxane), a polyorganosiloxane (e.g., a poly(diC₁₋₁₀alkyl siloxane) such as a poly(dimethyl siloxane), a poly(C₆₋₂₀aryl C₁₋₁₀ alkyl siloxane) such as a poly(phenyl methyl siloxane), and a poly(diC₆₋₂₀aryl siloxane) such as a poly(diphenyl siloxane)), and others], a silane [a silane compound (e.g., a mono- to tetraC₁₋₁₀ alkylsilane compound such as dimethylsilane, trimethylsilane and tetramethylsilane, a mono- to tetraC₆₋₂₀arylsilane compound such as triphenylsilane and tetraphenylsilane, a halosilane compound such as chlorotriphenylsilane, dichlorodiphenylsilane and dichloromethylphenylsilane), a polysilane compound (e.g., a polydiC₁₋₁₀alkylsilane such as a polydimethylsilane, a polyC₁₋₁₀alkylC₆₋₂₀arylsilane such as a polymethylphenylsilane, a polydiC₆₋₂₀arylsilane such as a polydiphenylsilane, and others)].

The silicone compound may have at least one (at least two, in particular) functional group(s) (e.g., a reactive group, a condensable group, and a polymerizable group). Examples of such a functional group may include a hydrolytic condensable group (e.g., a halogen atom, a hydroxyl group and an alkoxy group), an ether group, an epoxy group, a carboxyl group, a mercapto group, an amino group or a substituted amino group (e.g., a dialkylamino group), a polymerizable unsaturated group (e.g., a vinyl group, an allyl group and a (meth)acryloyl group), an isocyanate group, and the like. These functional groups may be located in a main chain terminal of the silicone compound and/or a side chain thereof, and are usually in the terminal position of the silicone compound. The functional group may be a functional group cross-linkable to the binder resin and/or the carbon fiber, or a self-condensable group such as the condensable group (e.g., the hydrolytic condensable group).

The silicone compound includes, for example, an polyorganosiloxane having the functional group (e.g., a modified polyorganosiloxane having a hydroxyl group, a C₁₋₂alkoxy group, an epoxy group, and others at both terminals), a silane having the functional group (e.g., a silane coupling agent) [e.g., an halogen-containing alkoxysilane (e.g., a 2-chloroethyltriC₁₋₂alkoxysilane), an alkoxysilane having an epoxy group (e.g., a 2-glycidyloxyethyltriC₁₋₂alkoxysilane), an alkoxysilane having an amino group (e.g., a 2-aminoethyltriC₁₋₂ alkoxysilane), an alkoxysilane having a mercapto group (e.g., a 2-mercaptoethyltriC₁₋₂alkoxysilane), an alkoxysilane having a vinyl group (e.g., a vinyltriC₁₋₂ alkoxysilane), and an alkoxysilane having an ethylenic unsaturated group (e.g., a 2-(meth)acryloxyethyltriC₁₋₂ alkoxysilane)], and others.

Among these silicone compounds, an organosiloxane [especially, a polyorganosiloxane (e.g., a poly(diC₁₋₆ alkyl siloxane) such as a poly(dimethyl siloxane), and a poly(C₆₋₁₀aryl C₁₋₆alkyl siloxane))], a silane coupling agent, or a combination of these compounds is preferred. These silicone compounds may be used singly or in combination.

These fire resistant agents may be used in a solvent free form, in the form of a solution or an emulsion, or the like.

These fire resistant agents may be used singly or in combination. Moreover, the fire resistant agent may be used in combination with other conventional flame retardant(s) as well.

The proportion of the fire resistant agent is about 1 to 30 parts by weight (e.g., about 1.5 to 25 parts by weight), preferably 2 to 20 parts by weight, and more preferably about 5 to 15 parts by weight, relative to 100 parts by weight of the carbon fiber.

The proportion of the fire resistant agent relative to the binder resin may be selected from within the range of about 1 to 100 parts by weight, and may be, for example, about 1 to 70 parts by weight (e.g., about 3 to 20 parts by weight), preferably about 6 to 70 parts by weight, more preferably about 10 to 50 parts by weight (particularly, about 10 to 40 parts by weight), and usually about 20 to 30 parts by weight, relative to 100 parts by weight of the binder resin. Moreover, the proportion of the fire resistant agent relative to the binder resin may be about 5 to 50 parts by weight (e.g., about 5 to 10 parts by weight) relative to 100 parts by weight of the binder resin. In the present invention, a large amount of the fire resistant agent can be added without deteriorating the characteristics of the binder resin.

These fire resistant agents may be used in combination with other component(s), for example, an inorganic compound such as an inorganic oxide [e.g., a silica (e.g., a colloidal silica (SiO₂)), an alumina, and others].

[Carbon Fiber Felt and Heat Insulating Material]

The bulk density of the carbon fiber felt may be selected according to the usage, and may be, for example, about 1 to 30 kg/m³, preferably about 3 to 25 kg/m³, and more preferably about 5 to 25 kg/m³ (especially about 8 to 25 kg/m³). In the view of fire resistance, the bulk density is preferred to be large.

The thickness of the carbon fiber felt may be selected according to the usage, and is not restricted to a specific one. The thickness may be about 1 to 100 mm, preferably about 5 to 50 mm, and more preferably about 10 to 30 mm.

The carbon fiber felt of the present invention may be obtained by bonding (or uniting) the carbon fiber aggregate (e.g., the web of the carbon fiber) with the binder resin in the presence of the fire resistant agent. When the binder resin is a thermosetting resin, the binder resin is adhered (or attached) to the carbon fiber aggregate (e.g., the web of the carbon fiber), and then the binder resin may be cured to obtain the carbon fiber felt. The fire resistant agent may be applied to the carbon fiber aggregate in advance, however, the fire resistant agent is usually included into the binder resin from the viewpoint of convenience. The binder resin and the fire resistant agent are ordinarily used, in combination with a solvent, as a mixture in many cases.

The method for applying the binder resin to the carbon fiber aggregate (e.g., the web of the carbon fiber) includes not only a method of impregnating a solution comprising the binder resin (binder resin solution, or a mixture containing the resin and the fire resistant agent) with the carbon fiber aggregate (e.g., the web of the carbon fiber), but also a method of spraying a binder resin solution (or a mixture containing the resin and the fire resistant agent) to the carbon fiber aggregate (e.g., the web of the carbon fiber), a method of applying or sprinkling a binder resin solution directly to the aggregate, and others. Incidentally, after the adhesion of the binder resin solution to the carbon fiber aggregate (e.g., the web of the carbon fiber), the solvent may be removed (usually by drying).

In the binder resin solution, the ratio (weight ratio) of the solvent relative to the binder resin [the solvent/the binder resin] is about 99/1 to 50/50, preferably about 95/5 to 55/45, and more preferably about 90/10 to 60/40.

When the fire resistant agent is included in the binder resin solution, the ratio (weight ratio) of the binder resin relative to the fire resistant agent [the binder resin/the fire resistant agent] may be, on solid bases, selected from within the range of about 99/1 to 50/50, and may be, for example, about 99/1 to 60/40 (e.g., about 97/3 to 80/20), preferably about 94/6 to 60/40, more preferably about 90/10 to 65/35, (particularly about 90/10 to 70/30), and usually about 80/20 to 75/25. The ratio (weight ratio) of the binder resin relative to the fire resistant agent [the binder resin/the fire resistant agent] may be, on solid bases, about 95/5 to 65/35 (e.g., about 95/5 to 90/10).

The solvent may vary depending on the kinds of the binder resin. A conventional solvent may be used, and may include, for example, water, an alcohol (e.g., ethanol and isopropanol), a halogenated hydrocarbon (e.g., methylene chloride), a ketone (e.g., acetone and methyl ethyl ketone), an ester (e.g., ethyl acetate), an ether (e.g., diethyl ether, tetrahydrofuran), a cellosolve (e.g., methyl cellosolve and ethyl cellosolve), an aromatic hydrocarbon (e.g., toluene), an aliphatic hydrocarbon (e.g., hexane), an alicyclic hydrocarbon (e.g., cyclohexane), and others. These solvents may be used singly or in combination.

These binder resins may be used in combination with other component(s), for example, an inorganic compound such as an inorganic oxide [e.g., a silica (e.g., a colloidal silica (SiO₂)) and an alumina].

When the binder resin is the thermosetting resin, the temperature at which the thermosetting resin is cured by heat may vary depending on the kinds of the thermosetting resin. The temperature is usually about 50 to 400° C., preferably about 70 to 300° C., and more preferably about 100 to 300° C. The curing time is usually about 1 minute to 24 hours, preferably about 1 minute to 10 hours, and more preferably about 3 minutes to 1 hour. When a phenol resin is used as the thermosetting resin, the resin may be cured, for example, at a temperature of about 150 to 300° C., (particularly, about 180 to 270° C.), for about 1 to 10 minutes (about 3 to 7 minutes).

The carbon fiber felt may be a monolayer, or a multilayer. Moreover, the carbon fiber felt may have a uniform density all over the felt, or have a density gradient in the direction of the thickness.

Incidentally, in order to obtain the carbon fiber felt with a certain bulk density, the carbon fiber aggregate (e.g., the web of the carbon fiber) may have a certain bulk density corresponding to the carbon fiber felt. Further, the carbon fiber felt with a certain bulk density may be prepared by adhering (or attaching) the binder resin to the carbon fiber aggregate (e.g., the web of the carbon fiber), then if necessary drying the resulting matter, and curing the resin the resin with mechanical compression. In order to enhance the bulk density of the carbon fiber felt, for example, the web of the carbon fiber to which the binder resin is adhered may be compressed mechanically by means of a compression manner such as a needle punch.

The felting step of the carbon fiber may be carried out discontinuously or continuously with the producing step of the carbon fiber.

Incidentally, the binder resin may be carbonated or graphitized by baking, if necessary.

In the present invention, the fire resistance of the carbon fiber felt can be improved, since the fire resistant agent is used. Moreover, the fire resistance of the carbon fiber felt can be improved without deteriorating the characteristic of the binder resin. Furthermore, the improvement of the fire resistance of the carbon fiber felt can be achieved with convenience and efficiency.

### INDUSTRIAL APPLICABILITY

The carbon fiber felt of the present invention contains the fire resistant agent, so the felt can be improved in fire resistance and also has strong resistance to higher temperature or higher heat. Moreover, the felt is excellent in a mechanical property and durability. Therefore, this carbon fiber felt or a fabricated (molded) article formed from this felt may be used as a variety of materials such as a heat insulating material, a filler, a reinforcing material, a cushioning material, and others. In particular, the deterioration in the physical characteristics of the felt can be restrained even at such a high temperature as about 200 to 500° C., e.g., about 300 to 400° C. Thus, the felt is suitable for a variety of heat insulating materials, e.g., the heat insulating materials for a rapid transportation such as an airplane, a rapid-transit railway vehicle and a space craft; the heat insulating materials for a high-temperature furnace such as a resistance furnace, an induction furnace, a vacuum deposition furnace, a semiconductor single crystal growth furnace, a ceramics sintering furnace and a C/C composite burning furnace; and the like.

### EXAMPLES

The following examples are intended to describe this invention in further detail and should by no means be interpreted as defining the scope of the invention. Incidentally, the used fire resistant agent and the method for evaluating fire resistance are shown as follows.

[Fire Resistant Agent]

Phosphoric ester: “CDP (cresyl diphenyl phosphate)”, manufactured by Daihachi Chemical Industry Co., Ltd.

Boric acid: manufactured by Wako Pure Chemical Industries, Ltd., guaranteed reagent grade.

Silicone Compound (S)

S-1: Fiber-treating agent, “Polon MF-33A” [containing an emulsifier and a poly(dimethyl siloxane) having hydroxyl groups at both terminals], manufactured by Shin-Etsu Chemical Co., Ltd.

S-2: “Polon MF-56” [containing an alkoxy silane, a colloidal silica, an emulsifier, and a poly(dimethyl siloxane) having hydroxyl groups at both terminals], manufactured by Shin-Etsu Chemical Co., Ltd.

S-3: “KM-2002L-1” [containing an alkoxy silane, a colloidal silica, an emulsifier, and a poly(dimethyl siloxane) having hydroxyl groups at both terminals], manufactured by Shin-Etsu Chemical Co., Ltd.

S-4: “KM-9739” [containing an alkoxy silane, a colloidal silica, an emulsifier, and a poly(methyl phenyl siloxane) having hydroxyl groups at both terminals], manufactured by Shin-Etsu Chemical Co., Ltd.

[Fire Resistance]

The obtained heat insulating materials were burned by a gas burner (calorie: 630,000 kJ/hour, distance between the gas burner and the felt: 150 mm), and the time required to make a hole in the heat insulating materials was measured. The longer the time is the higher the fire resistance is.

### Examples 1 to 3 and Comparative Example 1

The anisotropic pitch obtained from a polymerization of a condensed polycyclic hydrocarbon was subjected to a melt-spinning at 320° C. Then, the infusibility-giving treatment was carried out by heating the fiber at 300° C. for 30 minutes in an atmosphere of air. Further, the fiber was carbonized by heating at 750° C. for 30 minutes in an atmosphere of an inactive gas to obtain an anisotropic carbon fiber with a mean diameter of 1.5 μm. The carbon fiber was opened, the opened fiber was collected with spraying a phenol resin aqueous solution containing the fire resistant agent shown in Table 1, and then the carbon fiber aggregate containing the fire resistant agent was obtained. The carbon fiber aggregate was cured by heating at 250° C. for 10 minutes, and thus the carbon fiber felt (thickness 25 mm) with a bulk density of 7.5 kg/m³ was produced. Incidentally, the proportion of the fire resistant agent and that of the phenol resin, relative to 100 parts by weight of the carbon fiber, were 5 and 20 parts by weight, respectively. The evaluation results of the fire resistance were shown in Table 1.

TABLE 1

| | Comp. Ex. 1 | Ex. 1 | Ex. 2 | Ex. 3 |
|---|---|---|---|---|
| Fire resistant | none | Phosphoric | Boric | S-1 |
| agent | | ester | acid | |
| Fire resistance | 6 | 8 | 7 | 8 |
| (minutes) | | | | |

### Examples 4 to 6 and Comparative Example 2

The isotropic pitch obtained from a coal tar was subjected to a melt-spinning at 300° C. Then, the infusibility-giving treatment was carried out by heating the fiber at 320° C. for 30 minutes in an atmosphere of air. Further, the fiber was carbonized by heating at 750° C. for 30 minutes in an atmosphere of an inactive gas to obtain an isotropic carbon fiber with a mean diameter of 1.5 μm. The carbon fiber was opened, the opened fiber was collected with spraying a phenol resin aqueous solution containing the fire resistant agent shown in Table 2, and then the carbon fiber aggregate containing the fire resistant agent was obtained. The carbon fiber aggregate was cured by heating at 250° C. for 10 minutes, and thus the carbon fiber felt (thickness 25 mm) with a bulk density of 7.5 kg/m³ was produced. Incidentally, the proportion of the fire resistant agent and that of the phenol resin, relative to 100 parts by weight of the carbon fiber, were 5 and 20 parts by weight, respectively. The evaluation results of the fire resistance were shown in Table 2.

TABLE 2

| | Comp. Ex. 2 | Ex. 4 | Ex. 5 | Ex. 6 |
|---|---|---|---|---|
| Fire resistant | none | Phosphoric | Boric | S-1 |
| agent | | ester | acid | |
| Fire resistance | 2 | 3 | 2.5 | 3 |
| (minutes) | | | | |

### Examples 7 to 9

The anisotropic pitch obtained from a polymerization of a condensed polycyclic hydrocarbon was subjected to a melt-spinning at 320° C. Then, the infusibility-giving treatment was carried out by heating the fiber at 300° C. for 30 minutes in an atmosphere of air. Further, the fiber was further carbonized by heating at 750° C. for 30 minutes in an atmosphere of an inactive gas to obtain an anisotropic carbon fiber with a mean diameter of 1.5 μm. The carbon fiber was opened, the opened fiber was collected with spraying a phenol resin aqueous solution containing the fire resistant agent shown in Table 3, and then the carbon fiber aggregate containing the fire resistant agent was obtained. The carbon fiber aggregate was cured by heating at 250° C. for 10 minutes, and thus the carbon fiber felt (thickness 25 mm) with a bulk density of 7.5 kg/m³ was produced. Incidentally, the proportion of the fire resistant agent and that of the phenol resin, relative to 100 parts by weight of the carbon fiber, were 2 and 20 parts by weight, respectively. The evaluation results of the fire resistance were shown in Table 3.

TABLE 3

| | Ex. 7 | Ex. 8 | Ex. 9 |
|---|---|---|---|
| Fire resistant | Phosphoric | Boric acid | S-1 |
| agent | ester | | |
| Fire resistance | 7 | 6.5 | 7 |
| (minutes) | | | |

### Examples 10 to 15

The anisotropic pitch obtained from a polymerization of a condensed polycyclic hydrocarbon was subjected to a melt-spinning at 320° C. Then, the infusibility-giving treatment was carried out by heating the fiber at 300° C. for 30 minutes in an atmosphere of air. Further, the fiber was carbonized by heating at 750° C. for 30 minutes in an atmosphere of an inactive gas to obtain an anisotropic carbon fiber with a mean diameter of 1.5 μm. The carbon fiber was opened, the opened fiber was collected with spraying the phenol resin aqueous solution containing the fire resistant agent shown in Table 4, and then the carbon fiber aggregate containing the fire resistant agent was obtained. The carbon fiber aggregate was cured by heating at 250° C. for 10 minutes, and thus the carbon fiber felt (thickness 25 mm) with a bulk density of 7.5 kg/m³ was produced. Incidentally, the proportion of the fire resistant agent and that of the phenol resin, relative to 100 parts by weight of the carbon fiber, were 5 or 10 parts by weight, and 20 parts by weight, respectively. The evaluation results of the fire resistance were shown in Table 4.

TABLE 4

| | Ex. 10 | Ex. 11 | Ex. 12 | Ex. 13 | Ex. 14 | Ex. 15 |
|---|---|---|---|---|---|---|
| Fire resistant | S-2 | S-2 | S-3 | S-3 | S-4 | S-4 |
| agent | 5 | 10 | 5 | 10 | 5 | 10 |
| (parts by | | | | | | |
| weight) | | | | | | |
| Fire resistance | 8 | 10 | 8 | 10 | 8 | 10 |
| (minutes) | | | | | | |

As apparent from the results of the Tables, since the heat insulating materials of the Examples include the fire resistant agent, the materials show higher fire resistance. Moreover, the heat insulating materials made of the anisotropic pitch-based carbon fiber have higher fire resistance than those made of the isotropic pitch-based carbon fiber have. On the contrary, the heat insulating materials of the Comparative Examples contain no fire resistant agent, the materials do not have enough fire resistance.

1. A carbon fiber felt comprising a carbon fiber aggregate, and a binder resin to bond the carbon fiber constituting said aggregate, wherein the felt contains a fire resistant agent.

2. A felt according to claim 1, wherein the binder resin comprises a thermosetting resin.

3. A felt according to claim 1, wherein the fire resistant agent comprises at least one member selected from the group consisting of a phosphorus-containing compound, a boron-containing compound and a silicone compound.

4. A felt according to claim 1, wherein the fire resistant agent comprises a silicone compound having a reactive group.

5. A felt according to claim 1, wherein the fire resistant agent comprises a silicone compound having at least two reactive functional groups.

6. A felt according to claim 5, wherein the reactive functional group is at least one member selected from the group consisting of a hydrolytic condensable group, an ether group, an epoxy group, a carboxyl group, a mercapto group, an amino group, a substituted amino group, a polymerizable unsaturated group, and an isocyanate group; and the silicone compound comprises at least one member selected from the group consisting of an organosiloxane and a silane.

7. A felt according to claim 5, wherein the fire resistant agent comprises a polyorganosiloxane having at least one functional group selected from the group consisting of a halogen atom, a hydroxyl group and an alkoxy group.

8. A felt according to claim 1, wherein the proportion of the fire resistant agent is 1 to 30 parts by weight relative to 100 parts by weight of the carbon fiber.

9. A felt according to claim 1, wherein the proportion of the binder resin is 1 to 50 parts by weight relative to 100 parts by weight of the carbon fiber, and the proportion of the fire resistant agent is 1 to 70 parts by weight relative to 100 parts by weight of the binder resin.

10. A felt according to claim 1, wherein the binder resin contains the fire resistant agent.

11. A felt according to claim 1, wherein the carbon fiber comprises a fine carbon fiber.

12. A felt according to claim 1, wherein the mean diameter of the carbon fiber is 0.5 to 2 μm.

13. A felt according to claim 1, wherein the carbon fiber comprises a pitch-based carbon fiber.

14. A felt according to claim 1, wherein the carbon fiber comprises an anisotropic carbon fiber.

15. A felt according to claim 1, which comprises a web of the carbon fiber and a thermosetting resin for bonding the carbon fiber constituting said web, wherein the carbon fiber comprises an anisotropic pitch-based carbon fiber having a mean diameter of 0.5 to 5 μm and a mean length of 1 to 15 mm; and the felt contains at least one fire resistant agent selected from the group consisting of a phosphoric ester, a boric acid and a silicone compound, in a proportion of 1.5 to 25 parts by weight relative to 100 parts by weight of the carbon fiber.

16. A felt according to claim 15, wherein the mean diameter of the carbon fiber is 0.5 to 2 μm, the thermosetting resin comprises at least a phenol-series resin, and the fire resistant agent comprises the silicone compound having a reactive group; and the felt contains the fire resistant agent in a proportion of 2 to 20 parts by weight relative to 100 parts by weight of the carbon fiber.

17. A heat insulating material formed by the carbon fiber felt recited in claim 1.

18. A process for producing a carbon fiber felt comprising a carbon fiber aggregate and a binder resin, which comprises bonding the carbon fiber aggregate by the binder resin in the presence of a fire resistant agent.

19. A process according to claim 18, which comprises adhering a mixture containing a thermosetting resin and the fire resistant agent to the carbon fiber aggregate, and curing the thermosetting resin to obtain a carbon fiber felt having a bulk density of 1 to 30 kg/m³.
